(19) United States
(12) Patent Application Publication
(10) Pub. No.: US 2012/0118421 A1
(43) Pub. Date: May 17, 2012

(54) ENGINE STARTING DEVICE

(75) Inventors: Shingo SATO, Chiyoda-ku (JP); Shuichi TAKAHAMA, Chiyoda-ku (JP); Yoshiyuki OKADA, Himeji-shi (JP)

(73) Assignee: MITSUBISHI ELECTRIC CORPORATION, Tokyo (JP)

(21) Appl. No.: 13/079,582

(22) Filed: Apr. 4, 2011

(30) Foreign Application Priority Data
Nov. 11, 2010 (JP) 2010-252769

(51) Int. Cl. F16L 55/10

(52) U.S. Cl. 138/89

(57) ABSTRACT

An engine starting device includes a drainage member which is attached to an attachment hole provided in a machine casing of the device and drains water intruded in the device. The drainage member includes: a torso section; a neck section; a flange section and a claw section, which are integrally configured with the neck section, and in which when the neck section is fitted in the hole, the flange section comes in contact with the inside of the casing and the claw section comes in contact with the outside of the casing, at least one section of the claw section being formed on the outside of the torso section; and partition plates separated in parallel so as to be capable of being overlapped each other and easily deformed when the claw section is pressed from the outside to the inner periphery of the torso section at the claw section.

### BACKGROUND OF THE INVENTION

1. Field of the Invention

The present invention relates to engine starting devices and, more particularly, relates to a drainage structure of water intruded in the inside of an engine starting device.

2. Description of the Related Art

As a drainage structure of a conventional engine starting device, for example, there is a drainage member on an engine starting device disclosed in Patent Document 1.

Such a conventional drainage member is a resin member to be attached to a machine casing of the engine starting device, the drainage member is composed of a neck section to be fitted into an attachment hole provided in the machine casing and a torso section having a labyrinth structure which is for preventing the drainage member from being covered with water from the outside, and a drainage path passes through from the neck section to the torso section.

As attachment methods in which the drainage member is attached to the machine casing, there are methods as follows: a method 1 (Patent Document 1) in which the drainage member is fitted into an attachment hole of the machine casing from the outside to the inside, a method 2 (Patent Document 2) in which the drainage member is fitted into the machine casing from the inside to the outside, a method 3 (Patent Document 3) in which the drainage member is sandwiched by two machine casings with respect to an opened attachment hole, and the like.

In the aforementioned method 1 and method 2, the drainage member includes a claw section to be attached to the machine casing while being elastically deformed and a flange section which sandwiches the machine casing together with the claw section after attachment. Furthermore, in the method 3, the drainage member is configured such that the machine casings are sandwiched by two flange sections.

### PRIOR ART DOCUMENT

### Patent Document

[Patent Document 1] Japanese Unexamined Utility Model Publication No. 4-93466

[Patent Document 2] Japanese Unexamined Utility Model Publication No. 2-75958

[Patent Document 3] Japanese Unexamined Patent Publication No. 2007-14191

### PROBLEMS TO BE SOLVED BY THE INVENTION

In the engine starting devices of the aforementioned conventional examples, there are problems in that: as for the aforementioned attachment method 1 and the attachment method 2, the claw section is easy to be elastically deformed, the size of the claw section is limited in order not to deteriorate attachment properties, and it is likely to be dropped or embedded due to external force in the case of being insufficient in size; and as for the attachment method 3, the drainage member can be attached without being deformed and therefore the shape of the drainage member becomes difficult to be dropped or embedded; however, the drainage member needs to be attached in assembling the engine starting device and the position of the drainage member needs to be directed to the ground direction of a vehicle; therefore, a plurality of attachment hole positions are provided and thus an assembly device becomes complicated.

The present invention proposes a drainage structure which can satisfy the aforementioned difficulty to be dropped or embedded and easiness to be attached at the same time in consideration of drainage properties and waterproof properties based on the attachment method 2. Therefore, in this case, description will be made in detail on the attachment method 2.

As the drainage member according to the attachment method 2, for example, a shape shown in FIG. 6 to FIG. 8 is included. A drainage member 20 shown in FIG. 6 to FIG. 8 includes a flange section 20c and a claw section 20d, which sandwich the machine casing. The flange section 20c is formed so as to contact with the inside of the machine casing; and the claw section 20d is formed so as to contact with the outside of the machine casing.

In this case, the flange section 20c does not need to be deformed in attaching and the flange section 20c can be provided to be large in size; and therefore, the drainage member 20 can be difficult to be dropped to the outside of the engine starting device.

A water intake port 20m is provided on the upper side of the drainage member 20 and a drainage port 20n is provided on the lower side thereof; and a drainage path passes through from the water intake port 20m to the drainage port 20n. A partition plate 20e is provided in the drainage path for preventing water from entering from the outside.

In the drainage member 20 shown in FIG. 6 to FIG. 8, in order to avoid interference with components around the engine starting device, there is assumed the case where vertical height is limited; and, in order to lower the height, the claw section which is elastically deformed is provided at substantially the same height as the partition plate of the inner periphery of the drainage member.

In this case, a connecting portion of the partition plate 20e is high in rigidity against deformation to the inside; and therefore, an arrangement is made so that the claw section 20d is not located on the outside of a torso section 20a to which the partition plate 20e is connected. Next, problems of the drainage members 20 shown in FIG. 6 to FIG. 8 will be described.

In the attachment hole of the machine casing, in order to avoid interference between the components in the inside of the engine starting device and the drainage member, the attachment hole cannot be provided to be a circular shape and there is a case where the shape of the torso section 21a and the neck section 21b of the drainage member 21 is an oval or rectangular shape. A shape example at that case will be shown in FIG. 9 to FIG. 11.

As described above, an arrangement in which a claw section 21d is located on the outside of a connecting portion of a partition plate 21e needs to be avoided; however, in the case of the oval shape, even the claw section 21d is attached at the same position as FIG. 6 to FIG. 8, rigidity in a direction to be deformed in attaching becomes high. As a result, when attachment properties are taken into account, the height of the claw section 21d cannot be sufficiently provided and thus the drainage member 21 is easy to be embedded into the inside of the engine starting device.

### SUMMARY OF THE INVENTION

The present invention is implemented to solve the foregoing problem, and an object of the present invention is to provide an engine starting device capable of preventing a drainage member from being embedded into the engine starting device and capable of improving attachment properties.

### MEANS FOR SOLVING THE PROBLEMS

According to the present invention, there is provided an engine starting device including a resin-made drainage member which is attached to an attachment hole provided in a machine casing of the engine starting device and drains water intruded in the engine starting device. In the engine starting device, the drainage member includes: a torso section formed with a drainage path in the inside thereof; a neck section to be fitted into the attachment hole provided in the machine casing; a flange section and a claw section, which are integrally configured with the neck section, and in which when the neck section is fitted in the attachment hole provided in the machine casing, the flange section comes in contact with the inside of the machine casing and the claw section comes in contact with the outside of the machine casing, at least one section of the claw section being formed on the outside of the torso section; and a pair of partition plates separated in parallel so as to be capable of being overlapped each other and easily deformed when the claw section is pressed from the outside to the inner periphery of the torso section at the claw section.

### ADVANTAGEOUS EFFECT OF THE INVENTION

According to an engine starting device of the present invention, it becomes capable of preventing a drainage member from being embedded into the engine starting device and capable of improving attachment properties.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a relevant part sectional side view showing an engine starting device according to Embodiment 1 of the present invention;

FIG. 2 is a sectional view showing a drainage member on the engine starting device according to Embodiment 1 of the present invention;

FIG. 3 is a view in which the drainage member on the engine starting device according to Embodiment 1 of the present invention is seen from the front bracket side;

FIG. 4 is a sectional view taken along the line A-A of FIG. 2 showing the drainage member on the engine starting device according to Embodiment 1 of the present invention; and

FIG. 5 is a sectional view showing other example of a drainage member on the engine starting device according to Embodiment 1 of the present invention.

FIG. 6 is a view in which a drainage member on a conventional engine starting device is seen from the drainage port side;

FIG. 7 is a sectional view taken along the line B-B of FIG. 6 showing the conventional engine starting device; and

FIG. 8 is a sectional view taken along the line C-C of FIG. 7 showing the conventional engine starting device.

FIG. 9 is a view in which a drainage member on other conventional engine starting device is seen from the drainage port side;

FIG. 10 is a sectional view taken along the line D-D of FIG. 9 showing other conventional engine starting device; and

FIG. 11 is a sectional view taken along the line E-E of FIG. 10 showing other conventional engine starting device.

### DETAILED DESCRIPTION OF THE INVENTION

### Embodiment 1

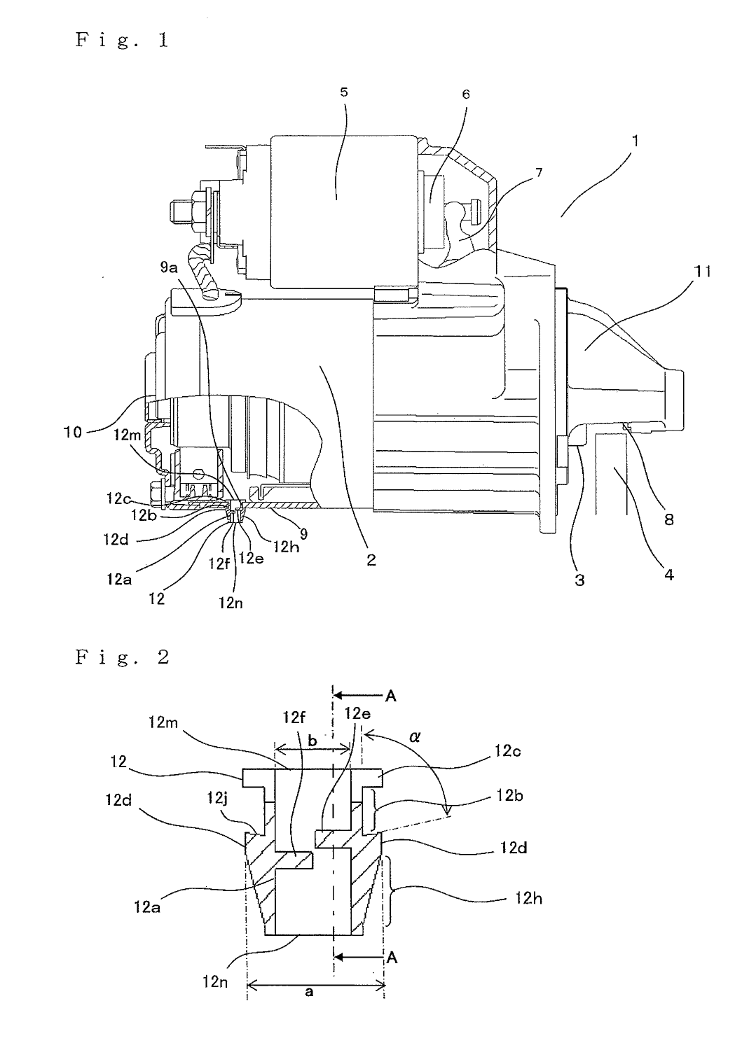

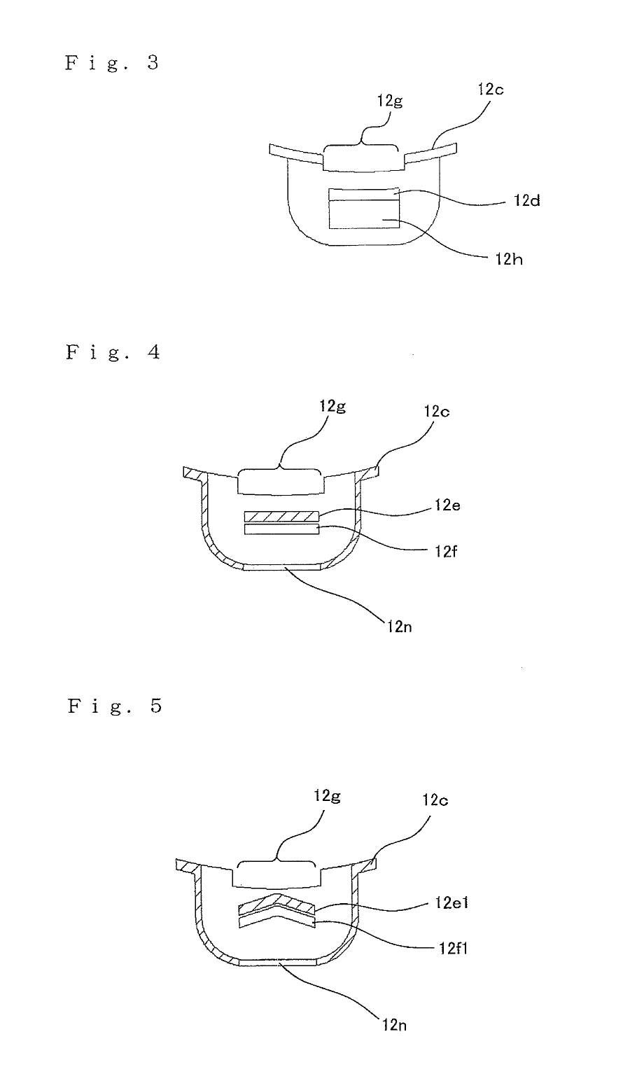

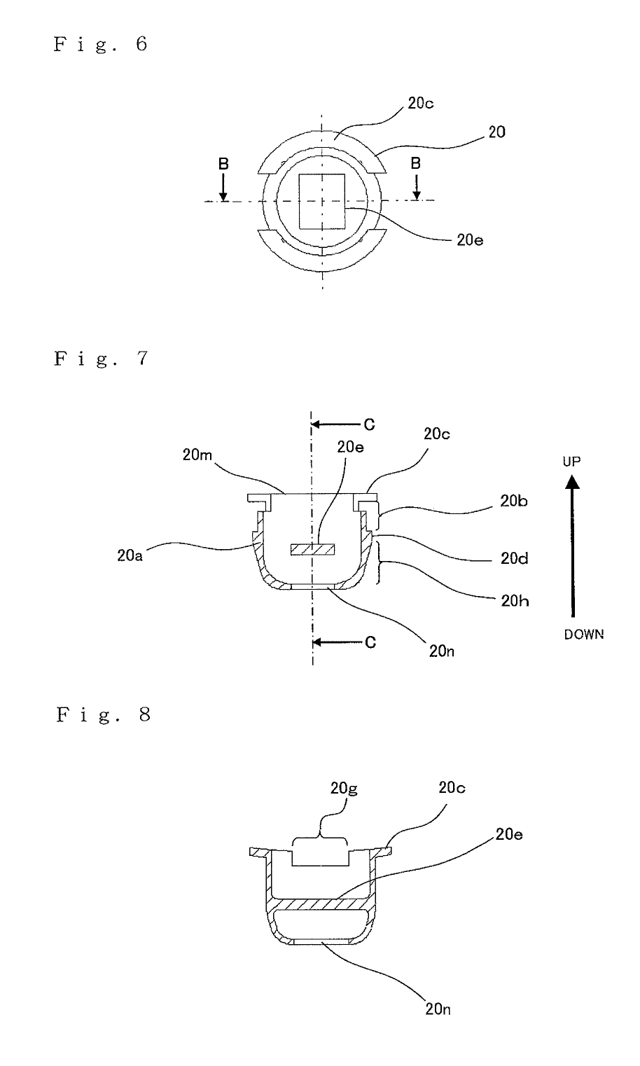

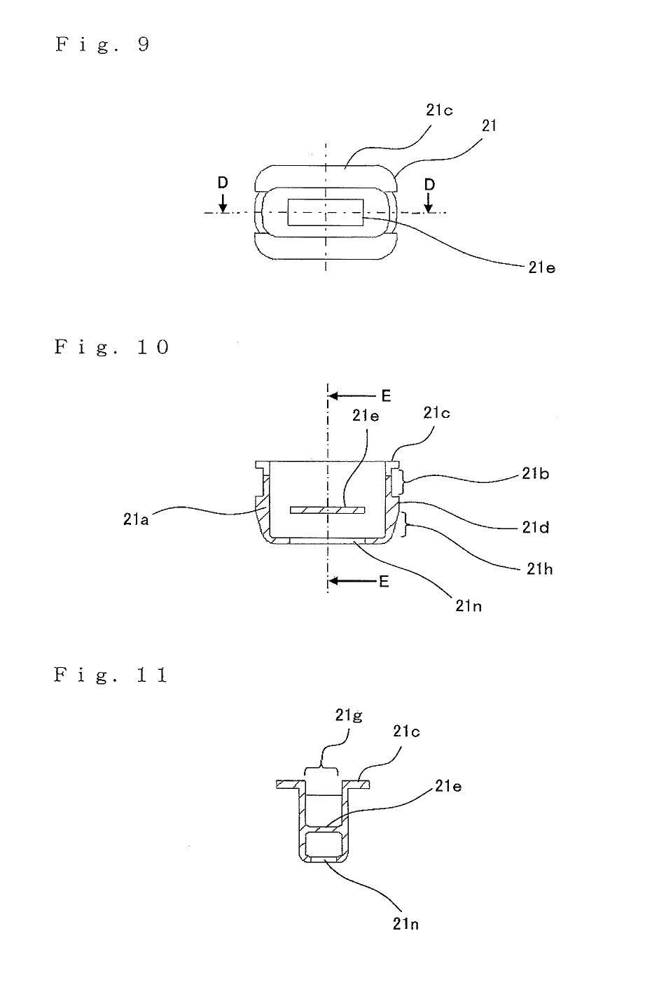

Hereinafter, Embodiment 1 of the present invention will be described with reference to FIG. 1 to FIG. 5; however, in each of the drawings, identical or equivalent members and portions will be described with the same reference numerals assigned thereto. FIG. 1 is a relevant part sectional side view showing an engine starting device according to Embodiment 1 of the present invention. FIG. 2 is a sectional view showing a drainage member on the engine starting device according to Embodiment 1 of the present invention. FIG. 3 is a view in which the drainage member on the engine starting device according to Embodiment 1 of the present invention is seen from the front bracket side. FIG. 4 is a sectional view taken along the line A-A of FIG. 2 showing the drainage member on the engine starting device according to Embodiment 1 of the present invention. FIG. 5 is a sectional view showing other example of a drainage member on the engine starting device according to Embodiment 1 of the present invention.

In these drawings, reference numeral 1 denotes an engine starting device, and 2 denotes a motor unit which generates rotational energy by being energized. 3 denotes a pinion and the rotational energy generated by the motor unit 2 is transmitted to an engine ring gear 4 through the pinion 3. 5 denotes a switching device having a solenoid (not shown in the drawing) in the inside thereof. 6 denotes a plunger which is sucked to the inside of the switching device 5 by energizing the solenoid of the switching device 5. 7 denotes a shift lever which transmits a movement of the plunger 6 to the pinion 3. 8 denotes a stopper which controls a movement of the pinion 3. 9 denotes a machine casing of a yoke which constitutes a part of the motor unit 2, 10 denotes a rear bracket, and 11 denotes a front bracket.

Next, operation of the engine starting device 1 will be briefly described. When the solenoid of the switching device 5 is energized, the plunger 6 is sucked and the plunger 6 starts to move to the left side in FIG. 1. Along with a movement thereof, the pinion 3 is extruded to the right side in FIG. 1 through the shift lever 7 loosely inserted in the plunger 6, and the pinion 3 comes in contact with the engine ring gear 4. After that, when the pinion 3 is engaged with the engine ring gear 4, the pinion 3 moves to the right side in FIG. 1 until the pinion 3 comes in contact with the stopper 8 of the engine starting device 1, and the rotational energy is transmitted to the engine ring gear 4 to start up an engine.

Next, a drainage structure of water intruded in the engine starting device 1 will be described. 12 denotes a drainage member which is attached to an attachment hole 9a of the machine casing 9 of the yoke of the engine starting device 1 and the drainage member 12 has a role to drain when the engine starting device 1 is covered with water and the water intrudes inside the engine starting device 1.

In this case, the drainage member 12 is made of resin. As shown in FIG. 2, the drainage member 12 includes: a torso section 12a formed with a drainage path in the inside thereof; a neck section 12b to be fitted into the attachment hole 9a provided in the machine casing 9 of the yoke; a flange section 12c and a claw section 12d, which are integrally configured with the neck section 12b, and in which when the neck section 12b is fitted in the attachment hole 9a provided in the machine casing 9, the flange section 12c comes in contact with the inside of the machine casing 9 and the claw section 12d comes in contact with the outside of the machine casing 9, at least one section of the claw section 12d being formed on the outside of the torso section 12a; and a pair of partition plates 12e, 12f which are arranged by being vertically shifted so as not to be butted and are vertically separated in parallel so as to be capable of being overlapped each other and easily deformed when the claw section 12d is pressed from the outside to the inner periphery of the torso section 12a at the claw section 12d. Incidentally, the drainage member 12 is provided with a water intake port 12m and a drainage port 12n.

The flange section 12c and the claw section 12d of the drainage member 12 are gently curved along a cylindrical shape of the machine casing 9 of the yoke in order to secure waterproof properties.

Furthermore, the flange section 12c of the drainage member 12 is provided with a slit 12g so as to facilitate water in the inside of the machine casing 9 of the yoke to be removed. In order to improve shape forming properties, the slit 12g is located at a position to be overlapped with the claw section 12d when seen from an attaching direction of the drainage member 12, that is, when seen from an upper direction of the drainage member 12. Such an arrangement is made; and accordingly, the configuration of a die can be simplified and an improvement in shape forming properties can be achieved.

Furthermore, the flange section 12c is not provided at a portion of the slit 12g; and therefore, a labyrinth structure cannot be formed between the machine casing 9 of the yoke and the slit 12g portion. However, in this embodiment, the labyrinth structure is formed between the claw section 12d and the machine casing 9 of the yoke; and therefore, it becomes possible to prevent water from intruding from the slit 12g portion and an improvement of waterproof properties can be achieved.

The claw section 12d of the drainage member 12 is provided with a tapered section 12h so that the drainage member 12 is easy to be deformed to the inside when the drainage member 12 is attached into the attachment hole 9a provided in the machine casing 9 of the yoke.

Then, the inside of the drainage member 12 has the partition plates 12e, 12f so as to form the labyrinth structure in order to prevent water from intruding from the outside, that is, from the drainage port 12n.

Next, attachment means of the drainage member 12 to the machine casing 9 of the yoke will be described. The aforementioned drainage member 12 is fitted and attached by being pressed from the inside of the machine casing 9 of the yoke to the outside of the machine casing 9.

In mid flow of the attachment, the drainage member 12 is inserted from the tapered section 12h to the attachment hole 9a provided in the machine casing 9 of the yoke while deforming the claw section 12d gradually; and when the drainage member 12 reaches the neck section 12b, the deformation of the drainage member 12 is restituted and the attachment is completed. Finally, the drainage member 12 is fixed in a sandwiched manner that the machine casing 9 of the yoke is sandwiched by the flange section 12c and the claw section 12d.

By the way, when the drainage member 12 is fitted into the attachment hole 9a provided in the machine casing 9 of the yoke while deforming the claw section 12d of the drainage member 12, a pair of the partition plates 12e, 12f provided being vertically separated in parallel to the inner periphery of the torso section 12a at the claw section 12d are easily deformed in a horizontal direction by pressing force from the outside of the claw section 12d so as to be overlapped each other without butting, the drainage member 12 can be easily attached to the machine casing 9 of the yoke, and the drainage member 12 is not embedded into the engine starting device 1.

Furthermore, the partition plates 12e, 12f of the drainage member 12 are arranged by being vertically separated in parallel in the horizontal direction as shown in FIG. 4; however, the present invention is not limited to this. For example, as shown in FIG. 5, the shape of partition plates 12e1, 12f1 are formed by being bent in a chevron shape, for example, and end portions are formed toward the drainage port 12n side of the drainage path of the drainage member 12; and accordingly, drainage properties can be further improved.

Incidentally, in the aforementioned Embodiment 1, the description has been made on the case where the drainage member 12 is attached to the machine casing 9 of the yoke that is the motor unit 2 as the machine casing of the engine starting device 1; however, the present invention is not limited to this. A rear bracket 10 or a front bracket 11 may be served as the machine casing of the engine starting device 1 and the attachment hole which is for attaching the drainage member 12 is provided in such bracket; and accordingly, the drainage member 12 can be attached in the same manner and the same effects as the aforementioned Embodiment 1 can be exhibited.

According to the aforementioned configuration, in a deforming direction of the claw section 12d of the drainage member 12 in attaching the drainage member 12, a space is formed between the partition plates 12e, 12f and the torso section 12a which forms the drainage path; and therefore, rigidity of the drainage member 12 against the deformation to the inside of the claw section 12d is lowered. As a result, a contact area between the claw section 12 and the machine casing 9 can be broadened; and therefore, the drainage member 12 can be formed in a shape that is difficult to be embedded into the engine starting device 1 and attachment properties can also be further improved.

This effect can be obtained until the amount of deformation of the claw section 12d reaches ½ of the width of the neck section 12b. That is, in the present invention, the partition plates 12e, 12f in the inside of the drainage member 12 are separated; and accordingly, the claw section 12d of the drainage member 12 is easy to be deformed and assembly properties can be facilitated. This effect can be obtained in a state where there is a space between the separated partition plates 12e, 12f and the inner walls of the drainage member 12; however, after the partition plates 12e, 12f come in contact with the inner walls, the effect by the separation of the partition plates 12e, 12f is eliminated and the rigidity against the deforming direction is drastically increased.

In this case, the distance between the partition plates 12e, 12f and the inner walls is the longest in the case where the partition plates 12e, 12f are separated at the center; and therefore, the effect that improves the assembly properties by the separation of the partition plates 12e, 12f is in the case of ½ of the length of the neck section 12b (to be exact, length in which the thickness of the drainage member 12 is subtracted from the length of the neck section 12b).

Furthermore, the surface of the claw section 12d, which faces the machine casing 9, can reduce a component of a load in which the claw section 12d deforms to the inside in the case where the load is applied to a direction in which the drainage member 12 is embedded, and strength against embedment can be further enhanced.

Furthermore, the surface 12j of the claw section 12d, which faces the machine casing 9, of the drainage member 12 is configured so as to be disposed at a sharp angle with the outer periphery surface of the machine casing 9. That is, as shown in FIG. 2, the torso section 12a side of the surface 12j of the claw section 12d, which faces the machine casing 9, of the drainage member 12 is formed in a tapered shape so as to be located on the drainage port 12n side with respect to the external end side of the surface 12j of the claw section 12d, which faces the machine casing 9, of the drainage member 12; and accordingly, the external end side of the surface 12j of the claw section 12d, which faces the machine casing 9, of the drainage member 12 comes in contact with the outer periphery surface of the machine casing 9 and is firmly fixed and this makes it possible to further efficiently prevent the drainage member 12 from being embedded into the machine casing 9.

Incidentally, according to Embodiment 1 of the present invention, an area of the drainage port 12n of the drainage member 12 scarcely changes; and therefore, conventional drainage properties can be secured.

While the presently preferred embodiments of the present invention have been shown and described. It is to be understood that these disclosures are for the purpose of illustration and that various changes and modifications may be made without departing from the scope of the invention as set forth in the appended claims.

What is claimed is:

1. An engine starting device comprising:
a resin-made drainage member which is attached to an attachment hole provided in a machine casing of said engine starting device and drains water intruded in said engine starting device,
wherein said drainage member includes:
a torso section formed with a drainage path in the inside thereof;
a neck section to be fitted into the attachment hole provided in said machine casing;
a flange section and a claw section, which are integrally configured with said neck section, and in which when said neck section is fitted in the attachment hole provided in said machine casing, said flange section comes in contact with the inside of said machine casing and said claw section comes in contact with the outside of said machine casing, at least one section of said claw section being formed on the outside of said torso section; and
a pair of partition plates separated in parallel so as to be capable of being overlapped each other and easily deformed when said claw section is pressed from the outside to the inner periphery of said torso section at said claw section.

2. The engine starting device according to claim 1,
wherein said partition plate has a shape formed by being bent in a chevron shape, and has end portions formed toward the drainage port side of the drainage path.

3. The engine starting device according to claim 1,
wherein said drainage member has a tapered section formed from an insertion surface to said claw section, the insertion surface being provided for making said drainage member fit from the inside to the outside of said machine casing.

4. The engine starting device according to claim 1,
wherein the amount of deformation of the width in a direction to be deformed in attaching said drainage member is not more than b/2.

5. The engine starting device according to claim 3,
wherein the surface of said claw section, which faces said machine casing, is configured so that an angle α is a sharp angle.

6. The engine starting device according to claim 1,
wherein said flange section is provided with a slit at a position to be overlapped with said claw section when seen from a direction in which said drainage member is attached to said machine casing.

7. The engine starting device according to claim 1,
wherein said flange section and said claw section have a curved shape along a cylindrical shape of said machine casing.

8. The engine starting device according to claim 5,
wherein said flange section is provided with a slit at a position to be overlapped with said claw section when seen from a direction in which said drainage member is attached to said machine casing.

9. The engine starting device according to claim 5,
wherein said flange section and said claw section have a curved shape along a cylindrical shape of said machine casing.

10. The engine starting device according to claim 4,
wherein said partition plate has a shape formed by being bent in a chevron shape, and has end portions formed toward the drainage port side of the drainage path.

11. The engine starting device according to claim 4,
wherein said drainage member has a tapered section formed from an insertion surface to said claw section, the insertion surface being provided for making said drainage member fit from the inside to the outside of said machine casing.

12. The engine starting device according to claim 4,
wherein said flange section is provided with a slit at a position to be overlapped with said claw section when seen from a direction in which said drainage member is attached to said machine casing.

13. The engine starting device according to claim 4,
wherein said flange section and said claw section have a curved shape along a cylindrical shape of said machine casing.

14. The engine starting device according to claim 10,
wherein said drainage member has a tapered section formed from an insertion surface to said claw section, the insertion surface being provided for making said drainage member fit from the inside to the outside of said machine casing.

15. The engine starting device according to claim 14,
wherein the surface of said claw section, which faces said machine casing, is configured so that an angle α is a sharp angle.

16. The engine starting device according to claim 15,
wherein said flange section is provided with a slit at a position to be overlapped with said claw section when seen from a direction in which said drainage member is attached to said machine casing.

17. The engine starting device according to claim 15,
wherein said flange section and said claw section have a curved shape along a cylindrical shape of said machine casing.

18. The engine starting device according to claim 11,
wherein the surface of said claw section, which faces said machine casing, is configured so that an angle a is a sharp angle.

19. The engine starting device according to claim 18,
wherein said flange section is provided with a slit at a position to be overlapped with said claw section when seen from a direction in which said drainage member is attached to said machine casing.

20. The engine starting device according to claim 18,
wherein said flange section and said claw section have a curved shape along a cylindrical shape of said machine casing.
